(19) United States
(12) Patent Application Publication
(10) Pub. No.: US 2026/0369466 A1
(43) Pub. Date: Nov. 19, 2026

(54) MOLDED COIL AND REACTOR, AND METHODS FOR MANUFACTURING THE MOLDED COIL AND THE REACTOR

(71) Applicant: Tamura Corporation, Tokyo (JP)

(72) Inventors: Kotaro Suzuki, Sakado-shi (JP); Kosuke Shibasaki, Sakado-shi (JP)

(21) Appl. No.: 19/408,536

(22) Filed: Dec. 4, 2025

(30) Foreign Application Priority Data
Dec. 5, 2024 (JP) 2024-212497

(51) Int. Cl. H01F 27/40; H01F 27/28; H01F 27/30; H01F 27/32; H01F 41/061; H01F 41/12

(52) U.S. Cl. CPC H01F 27/406; H01F 27/2823; H01F 27/306; H01F 27/327; H01F 41/061; H01F 41/12

(57) ABSTRACT

A molded coil includes a sensor bracket to which a sensor is attached and which is installed on a coil, and a molding resin that covers at least the coil and a part of the sensor. The sensor bracket is provided with an engagement groove into which the sensor is inserted. The engagement groove includes an opening that surrounds the entire circumference of a body of the sensor, and a pair of gripping surfaces which holds the sensor from both sides thereof within the engagement groove.

One of the gripping surfaces is an elastic plate piece which spreads in the depthwise direction of the engagement groove, has one end fixed, and has the other end as a free end.

### CROSS-REFERENCE TO RELATED APPLICATION

This application is based upon and claims the benefit of priority from Japan Patent Application No. 2024-212497, filed on Dec. 5, 2024, the entire contents of which are incorporated herein by reference.

### FIELD OF THE INVENTION

The present disclosure relates to a molded coil that has a coil covered with a resin, a reactor including the molded coil, a method for manufacturing the molded coil, and a method for manufacturing the reactor.

### BACKGROUND

A coil generates magnetic flux in accordance with the number of turns when energized. Therefore, a coil is utilized as an electromagnetic component which converts electrical energy into magnetic energy, and which charge or discharge such energy. A Coil is also called a reactor that is utilized in a wide variety of applications. Examples of application fields for coils, also called reactors, include step-up reactors, series reactors, parallel reactors, current-limiting reactors, starting reactors, shunt reactors, neutral-point reactors, and arc-suppression reactors.

A step-up reactor is incorporated into on-vehicle boost circuits such as drive systems of hybrid vehicles and electric vehicles. A series reactor is connected in series to a motor circuit, and limits current when a short-circuit occurs. A parallel reactor stabilizes current sharing among parallel circuits. A current-limiting reactor limits current when a short-circuit occurs. A starting reactor is connected in series to a motor circuit to protect equipment, and limits starting current. A shunt reactor is connected in parallel to a transmission line to compensate leading reactive power and suppresses abnormal voltages. A neutral-point reactor is connected between a neutral point and ground and is utilized to limit a ground-fault current when a ground-fault accident occurs in a power system. An arc-suppressing reactor automatically extinguishes an arc produced when a ground fault occurs at any one of the lines in a three-phase power system.

There is frequent demand that reactors be equipped with sensors that detect physical quantities such as the temperature of the reactor. A lead wire extends from the sensor. A connector is attached to an end of the lead wire, and via the connector and the lead wire the sensor is electrically connected to external equipment. The lead wire includes a metal wire, and a cover portion formed of an insulating member that covers the metal wire. The sensor is protected by being molded on its own or by being attached to a separate sensor cover.

### SUMMARY OF THE INVENTION

The coil may be covered with a resin. By covering the coil with resin, a core on which the coil is mounted and the coil are electrically insulated from each other. The coil covered with resin is called a molded coil. The resin around the coil is formed by molding so as to enhance the intimate contact between the coil and the resin.

When a sensor is provided on a coil, the sensor may also be covered with resin together with the coil at the time of molding to produce a molded coil. The injection pressure of the resin for molding the coil may excessively depress the lead wire extended from the sensor, and thus the lead wire may be disconnected. Moreover, the heat of the resin may melt the cover portion of the lead wire.

Accordingly, there is a technology of protecting the sensor against the disconnection of the lead wire due to the injection pressure of the resin and the melting of the cover portion of the lead wire due to the heat of the resin when the sensor together with the lead wire is individually molded or is attached to, together with the lead wire, the sensor cover that is a separate component.

When, however, the sensor is individually molded, or is attached to the sensor cover that is a separate component, the number of components of a product increases. Moreover, extra steps are required, such as a process of molding the sensor individually, and a process of attaching the sensor cover to the sensor.

The present disclosure has been made in order to address the above-described technical problems, and an objective is to provide a molded coil, a reactor, and methods for manufacturing molded coil and reactor which can reduce the number of components, and which increase the production efficiency.

In order to address the above-described technical problems, a molded coil according to an embodiment of the present disclosure includes:
a coil;
a sensor bracket installed on the coil;
a sensor attached to the sensor bracket; and
a molding resin that covers at least the coil and a part of the sensor.

The sensor bracket is provided with an engagement groove into which the sensor is inserted.

The engagement groove includes an opening that surrounds an entire circumference of a body of the sensor, and a pair of gripping surfaces which holds the sensor from both sides thereof within the engagement groove.

Wherein either one of the gripping surfaces is an elastic plate piece which spreads in the depthwise direction of the engagement groove, has one end fixed, and has the other end as a free end.

The sensor may include a lead wire drawn from the opposite end to a fitting-side tip of the sensor inserted into the engagement groove, and the sensor may be disposed with the opposite end protruding from the engagement groove.

The sensor may include an engagement protrusion that is latched with the free end of the elastic plate piece, and the free end of the elastic plate piece may contact a basal portion of the engagement protrusion with pressure.

The other one of the pair of gripping surfaces may include a curved recess that guides a fitting-side tip of the sensor toward the bottom of the engagement groove.

The sensor bracket may include a space portion that is present so as to extend along the elastic plate piece at the side opposite to the engagement groove across the elastic plate piece, and the space portion may have a larger volume than a volume of a space defined by the curved recess and the sensor.

The coil may be formed so as to have a circular or rounded-rectangular cross section spreading along the vertical direction to the axis, at least the two coils may be provided which are arranged side by side with respective circumferential surfaces of the coils facing each other, the sensor bracket may be installed in such a way that the sensor enters a interval between the two coils, the sensor bracket may include a support plate which spreads along the axial direction of the coil, and which is fitted in the interval between the coils, the support plate may be notched along the axial direction of coil so as to include the engagement groove and the elastic plate piece, and a plate upper portion of the support plate may be made thicker than a plate lower portion thereof.

The support plate may increase the thickness along the outer circumferential shape of the coil.

The sensor may be a temperature sensor.

Moreover, in order to address the above-described technical problems, a reactor according to an embodiment of the present disclosure include:
the above-described molded coil; and
an annular core which includes a magnetic body, and which is attached to the molded coil.

Furthermore, in order to address the above-described technical problems, a manufacturing method according to an embodiment of the present disclosure is for a molded coil that includes a coil, a sensor, a sensor bracket to which the sensor is attached and which is disposed on the coil, and a molding resin that covers at least the coil and a part of the sensor, and this method includes:
an attachment process of attaching the sensor to the sensor bracket;
an installation process of installing the sensor bracket on the coil; and
a molding process of accommodating the coil on which the sensor bracket is installed in a die, and of injecting the mold resin therein.

The sensor bracket is provided with an engagement groove into which the sensor is inserted.

The engagement groove includes an opening that surrounds an entire circumference of a body of the sensor, and a pair of gripping surfaces which holds the sensor from both sides thereof in the engagement groove.

Either one of the gripping surfaces is an elastic plate piece which spreads in the depthwise direction of the engagement groove, has one end fixed, and has the other end as a free end.

The sensor includes a lead wire drawn from the opposite end to a fitting-side tip of the sensor inserted into the engagement groove.

In the attachment process, the sensor is press-fitted in the engagement groove while causing the elastic plate piece to be elastically deformed, and is placed in such a way that the opposite end from which the lead wire is drawn protrudes from the engagement groove.

Still further, in order to address the above-described technical problems, a manufacturing method according to an embodiment of the present disclosure is for a reactor, and includes an assembling process of attaching the molded coil to the core including a magnetic body after through the above-described molded coil manufacturing method.

According to the present disclosure, a molded coil, a reactor, and molded coil and reactor production methods which can reduce the number of components, and which increase the production efficiency can be obtained.

### BRIEF DESCRIPTION OF THE DRAWINGS

FIG. 1 is a perspective view illustrating principal components extracted from a reactor;

FIG. 2 is a perspective view of a molded coil equipped with a sensor;

FIG. 3 is a perspective view of the molded coil with a coil molding resin being omitted;

FIG. 4 is an exploded view of the molded coil;

FIG. 5 is a plan view of a top cover;

FIG. 6 is an enlarged perspective view of a sensor bracket to which a sensor is attached;

FIG. 7 is a cross-sectional view of the sensor bracket taken along an engagement groove and a wiring groove;

FIG. 8 is a perspective view of the sensor bracket as viewed from the back side;

FIG. 9 is a cross-sectional view of the sensor bracket taken along the orthogonal direction to the winding axis;

FIG. 10 illustrates a first sub process of attaching the sensor, and is a cross-sectional view of the sensor bracket taken along the winding axis through the engagement groove and the wiring groove;

FIG. 11 illustrates a second sub process of attaching the sensor, and is a cross-sectional view of the sensor bracket taken along the winding axis through the engagement groove and the wiring groove;

FIG. 12 illustrates a third sub process of attaching the sensor, and is a cross-sectional view of the sensor bracket taken along the winding axis through the engagement groove and the wiring groove;

FIG. 13 is a perspective view of the sensor bracket and the sensor in a molding process as viewed from the back side;

FIG. 14 is a cross-sectional view of the sensor bracket and a coil taken along the overall length of the sensor; and

FIG. 15 is a perspective view of a reactor covered with the coil-molding resin and with a core-molding resin.

### DETAILED DESCRIPTION OF THE EMBODIMENTS

Hereinafter, a molded coil, a reactor, and methods for manufacturing thereof according to the present disclosure will be described with reference to the drawings. In each drawing, in order to facilitate understanding to the present disclosure, thickness, dimensions, positional relations, ratios, and the shapes, etc., may be illustrated in an emphasized manner, but the present disclosure is not limited to such emphasis.

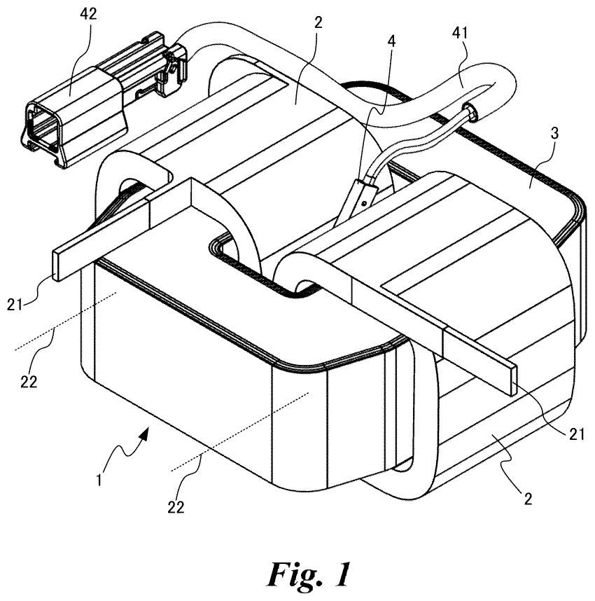

FIG. 1 is a perspective view of principal components extracted from a reactor 1. The reactor 1 includes coils 2 and a core 3. The coils 2 are fitted onto the core 3. Each coil 2 is a cylindrical wound body, has a conductive wire 21 led out therefrom, and is an inductor that generates magnetic fluxes in accordance with the number of turns when a current is caused to flow via the conductive wire 21 from a circuit into which the reactor 1 is incorporated, thus introducing inductive reactance into the circuit. The core 3 is an annular body including a magnetic body, and serves as a closed magnetic path that allows the magnetic fluxes generated by the coils 2 to pass through in accordance with the permeability that is higher than vacuum. Hence, the reactor 1 constitutes an electromagnetic component which converts electrical energy into magnetic energy, and which charges or discharges such energy.

Each coil 2 is formed by winding, in a rounded-rectangular cylindrical shape, the conductive wire 21 covered with an insulative covering like enamel cover. Each coil 2 is formed by winding the conductive wire 21 in a spiral shape while shifting the winding position thereof for each turn of winding along a winding axis 22. For example, the conductive wire 21 of each coil 2 is a flat rectangular wire, and each coil 2 is an edge-wise coil. The wide surface of the conductive wire 21 of each coil 2 extends in a direction orthogonal to the winding axis 22 of the coil 2. The kind of the conductive wire 21 is not limited to any particular kind, and the other kinds of wire may be applied like a wire with a circular cross-sectional shape. As for the coil 2, a flat-wise coil may also be applied.

The core 3 includes a magnetic body, such as a dust core, a ferrite core, a metal composite core or laminated steel plates. The dust core is an annealed powder molding component obtained by hardening the magnetic powders by pressurization. The magnetic powder is mainly composed of iron, and examples thereof include pure iron powders, permalloy (Fe—Ni alloy) mainly composed of iron, Silicon-containing iron alloy (Fe—Si alloy), sendust alloy (Fe—Si—Al alloy), amorphous alloy, nano-crystal alloy powders and the combination of two or more kinds of those materials. A metal composite core is a core formed by kneading the magnetic powders with a resin and by molding those.

The reactor 1 includes the plurality of coils 2, for example two. The plurality of coils 2 are arranged side by side in such a way that the respective winding axes 22 are extended in parallel, and the respective circumferential surfaces spreading along such winding axes 22 face each other. The reactor 1 is provided with a sensor 4. For example, the sensor 4 is a temperature sensor, but is not limited to thereto as long as it can detect the physical quantity of the reactor 1. That is, as for the sensor 4, an element capable of detecting other physical quantity, such as magnetic, electric, position, vibration, or humidity, may be applied. When the reactor 1 includes the plurality of coils 2, such a sensor 4 is inserted, for example, in an interval between the adjoining coils 2.

The sensor 4 has a contour shaped by a cover in a flat rectangular shape which has respective surfaces that are flat, and has an element contained therein. Among the respective surfaces of the sensor 4, from an end on the side opposite to an insertion-side tip inserted in between the adjoining coils 2, a lead wire 41 extends out. The lead wire 41 transmits an output signal of the sensor 4 to an external device. A connector 42 is attached to one end of the lead wire 41, and the sensor 4 is connected to the external device by such a connector 42.

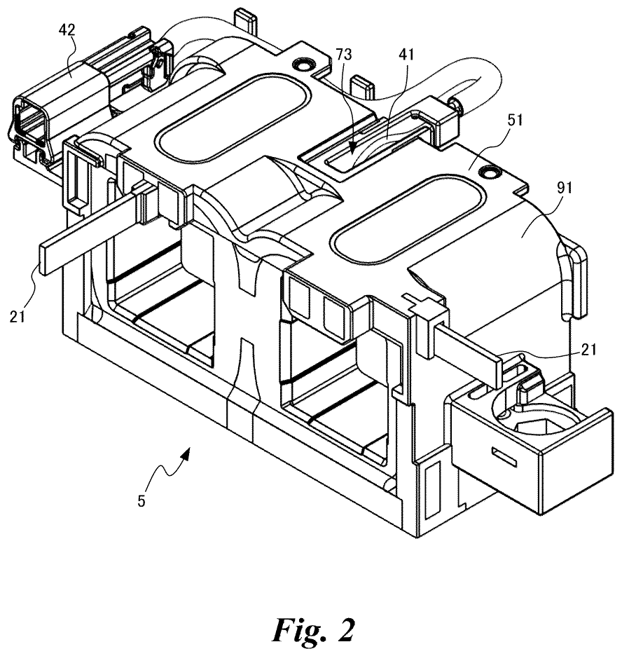

FIG. 2 is a perspective view of a molded coil 5 on which the sensor 4 is mounted. As illustrated in FIG. 2, the coils are covered with a resin 51, and are fitted onto the core 3. The plurality of coils 2 may be collectively covered with the resin 51, and then may be fitted onto the core 3. The coils 2 covered with the resin 51 will be referred to as the molded coil 5. The coil 2 is protected from mechanical shock, and is electrically insulated from the core 3 by being covered with the resin 51. The sensor 4 is also embedded in the resin 51. However, the sensor 4 is provided in the molded coil 5, and is not provided in the reactor 1. The lead wire 41 is exposed from the resin 51, and is disposed in a wiring groove 73 formed in the resin 51.

The resin 51 is an insulating member. Examples of the insulating member include, for example, an epoxy resin, an unsaturated polyester-based resin, a urethane resin, Bulk Molding Compound (BMC), Polyphenylene Sulfide (PPS), Polybutylene Terephthalate (PBT) or a combination of those, and a thermally-conductive filler may be mixed therein.

A part of the resin 51 is formed in a molding process. In the molding process, the coils 2 are accommodated in a die, a molten resin is injected into the die, and the molten resin is solidified. The solidified molten resin is a coil-molding resin 91. The coil-molding resin 91 formed in the molding process has high intimate contact to the coils 2. In the molding process, it is necessary to prevent the coils 2 from being damaged and the enamel cover of the conductive wire 21 from being peeled by the die. Moreover, in the molding process, the concavities and convexities of the coils 2 may be corrected by depressing the die, and the coils 2 may be compressed by the injection pressure of the molten resin. Furthermore, in the molding process, the portion of the coil 2 to be exposed may be isolated from the molten resin.

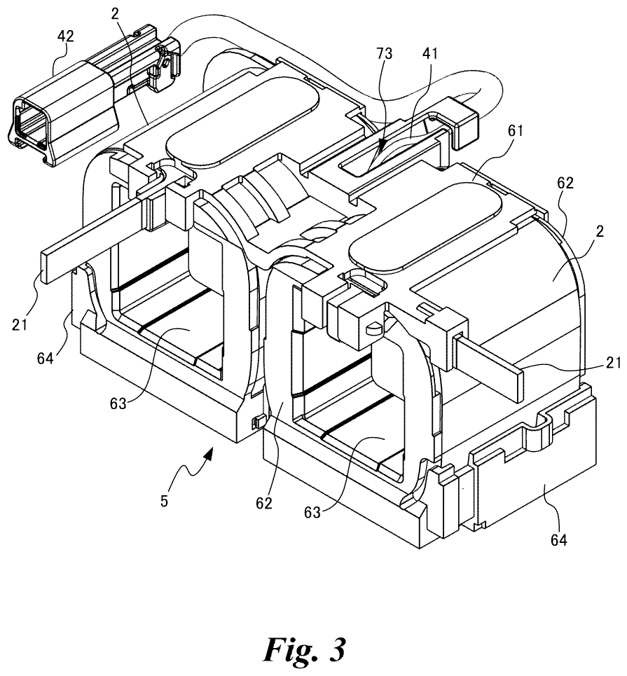

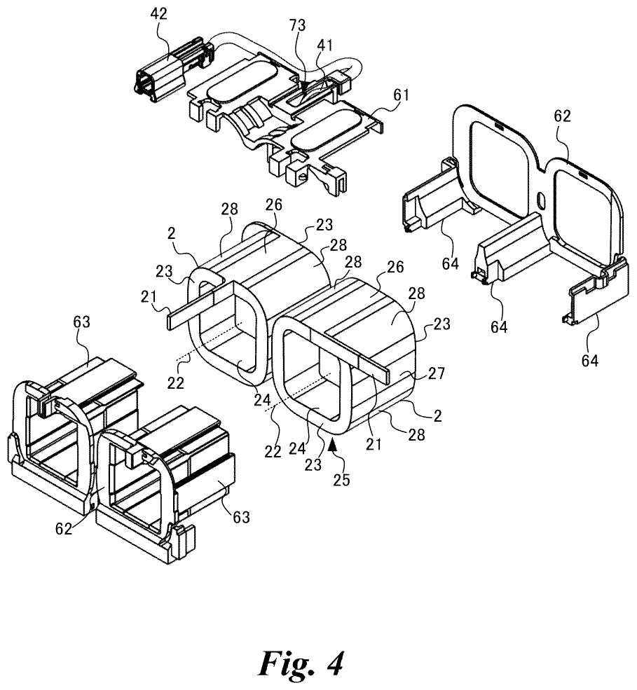

Accordingly, as illustrated in FIGS. 3 and 4, the resin 51 other than the coil-molding resin 91 constitutes to various covers 61 to 64, and in an installation process prior to the molding process, the respective surfaces of the coils 2 are covered by those covers 61 to 64.

FIG. 3 is a perspective view of the molded coil 5 with the coil-molding resin 91 being omitted, and FIG. 4 is an exploded view of such a molded coil 5. As illustrated in FIGS. 3 and 4, a top cover 61, end covers 62, inner circumferential cylinders 63, and side covers 64 are installed on the coils 2 in the installation process.

Each coil 2 includes a pair of end faces 23 which is orthogonal to the winding axis 22, and which belongs to the start winding of the conductive wire 21 and to the end winding thereof, respectively. Moreover, each coil 2 includes an inner circumferential surface 24, a bottom surface 25, a top surface 26 and side faces 27 which extend along the winding axis 22.

The four corners corresponding to a boundary between the top surface 26 and each side face 27, and to a boundary between the bottom surface 25 and each side face 27 are each a curved surface 28. The top surface 26 and each side face 27 are connected by such a rounded surface, and the bottom surface 25 and each side face 27 are connected by such a rounded surface.

The side faces 27 include, among the circumferential surface of the coil 2, a surface at which the adjoining two coils 2 face each other and a surface located on the side opposite to such a facing surface across the winding axis 22.

The bottom surface 25 is one surface held between the pair of side faces 27, and the top surface 26 is, among the surfaces held between the pair of side faces 27, an opposite surface to the bottom surface 25 across the winding axis 22 of the coil 2. The terms top and bottom correspond to the top side of the coil 2 and the bottom side thereof in the die in the molding process, respectively, and do not refer to the actual positional relation or orientation when the reactor 1 or the molded coil 5 is loaded on an actual device to which such a component is to be installed.

The top cover 61 is disposed on the top surfaces 26 of the respective coils 2. The sensor 4 is previously attached to the top cover 61 in an attachment process. The top cover 61 is disposed on the top faces 26 of the respective coils 2 in the installation process after the sensor 4 is attached. The end covers 62 are disposed on the respective both end faces 23 of each coil 2. The inner circumferential cylinder 63 is disposed on the inner circumferential surface 24 of each coil 2. The side cover 64 is disposed on each side face 27 of each coil 2.

Note that the end cover 62 and the side covers 64 disposed on the one-end-face-23 side of each coil 2 are an integrally molded component connected as a single continuous piece without seams. The end cover 62 and the inner cylindrical cylinder 63 disposed on the other-end-face-23 side of each coil 2 are also an integrally molded component connected as a single continuous piece without seams. The procedure in which each coil 2 is fitted into each inner circumferential cylinder 63 is a coil arrangement process in which the plurality of coils 2 are arranged side by side in such a way that respective circumferential surfaces face each other.

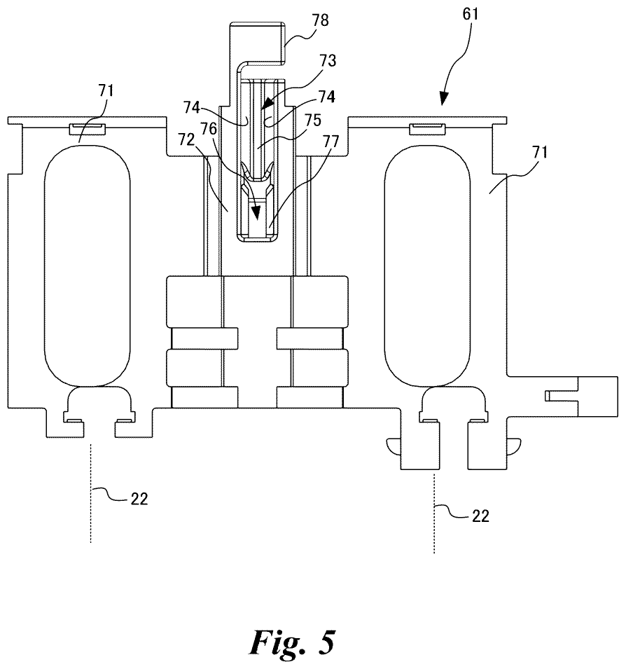

FIG. 5 is a plan view of the top cover 61. As illustrated in FIG. 5, the top cover 61 includes a circumferential cover 71 that covers the top surface 26 of the one coil 2, another circumferential cover 71 that covers the top surface 26 of the adjoining coil 2, and a sensor bracket 72 disposed between the two coils 2. The top cover 61 is an integrally molded component in which the two circumferential covers 71 and the sensor bracket 72 are connected as a single continuous piece without seams. Accordingly, the installation process of installing the top cover 61 on the coils 2 can also be considered as an installation process of installing the sensor bracket 72.

The sensor bracket 72 is elongated along the winding axis 22, and is provided between the two coils 2 so as to be elongated along those components. The sensor bracket 72 is provided with a wiring groove 73. The wiring groove 73 is provided in the sensor bracket 72, and extends along the interval between the two coils 2, i.e., along the winding axis 22. The wiring groove 73 is a wiring path for routing the lead wire 41, and is recessed one step from the surface of sensor bracket 72, and has a bottom surface.

The wiring groove 73 is defined by a bottom plate 75, and a pair of side wall plates 74 each standing upright from each side of the bottom plate 75, i.e., the side along the winding axis 22, and connected to the surface of the sensor bracket 72. The height of the side wall plate 74 and the width of the bottom plate 75 are equal to the diameter of the lead wire 41 drawn from the sensor 4, or is higher than such a diameter and wider than such a diameter.

An engagement groove 76 is formed in the wiring groove 73. The engagement groove 76 is formed in the bottom plate 75 of the wiring groove 73, and is formed so as to be deep from the top surface 26 of the coil 2 toward the bottom surface 25 thereof, in other words, is formed so as to extend deeply toward the bottom of the interval between the coils 2. The engagement groove 76 is a hole into which the sensor 4 is inserted.

An opening 77 for the engagement groove 76, i.e., the entrance through which the sensor 4 is inserted, or the portion of the wiring groove 73 on the bottom-plate-75 side is formed in a tapered shape that is gradually narrows in the direction penetrating the sensor bracket 72 from the wiring groove 73. The narrowest portion of the opening 77 of the engagement groove 76 is formed in the same shape and same dimension as those of the cross section of the sensor 4, enabling the insertion of the sensor 4. The engagement groove 76 is formed in, in the wiring groove 73, an end near the vicinity of the center of the coil 2 in the winding axis 22 of the coil 2.

Moreover, the sensor bracket 72 has a hook 78 which is provided near the wiring groove 73 and which catches the lead wire 41 drawn from the sensor 4. The hook 78 is disposed on the extended line of the wiring groove 73 so as to be spaced apart from the wiring groove 73, and is located on the side opposite the engagement groove 76, i.e., at the exterior of the sensor bracket 72. The hook 78 is formed in a gate like U-shape that has an opened part in a direction opposite to the concaved shape of the wiring groove 73.

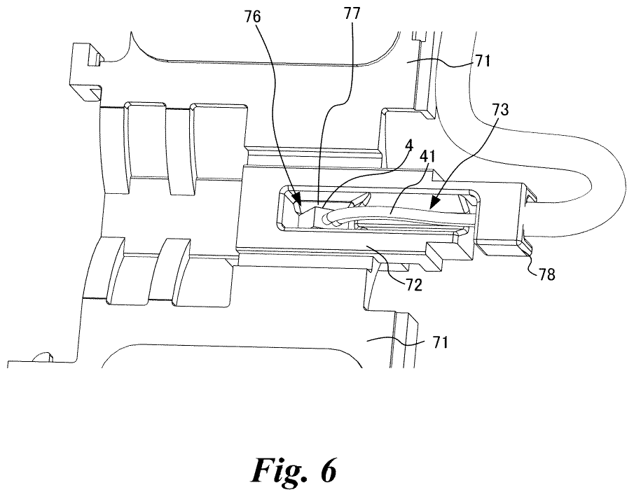

FIG. 6 is an enlarged perspective view of the sensor bracket 72 to which the sensor 4 is attached. As illustrated in FIG. 6, prior to the installation process of installing the top cover 61 on the coils 2, an attachment process of attaching the sensor 4 to the sensor bracket 72 is carried out. In the attachment process, the sensor 4 is inserted into the engagement groove 76 through the opening 77. The engagement groove 76 is shallower than the overall length of the sensor 4, and thus the end of the sensor 4 opposite to the fitting tip thereof protrudes from the engagement groove 76 in the inserted state.

The opening 77 of the engagement groove 76 is formed in a tapered shape. Therefore, the sensor 4 is slid and is inserted into the opening 77 of the engagement groove 76, and the entire circumference of the body of the sensor 4 is surrounded by the opening 77 of the engagement groove 76 substantially without any clearance. The end of the sensor 4 from which the lead wire 41 is drawn remains in the wiring groove 73.

The lead wire 41 is disposed so as to be laid over on the bottom plate 75 of the wiring groove 73 toward the hook 78. The lead wire 41 once exit out from the end opposite to the engagement groove 76 of the wiring groove 73, and is then caught by the hook 78. Since the engagement groove 76 is blocked off by the sensor 4, there is substantially no gap between the sensor 4 and the opening 77 of the engagement groove 76. Hence, the wiring groove 73 and the engagement groove 76 on which the lead wire 41 is laid over are blocked off by the sensor 4.

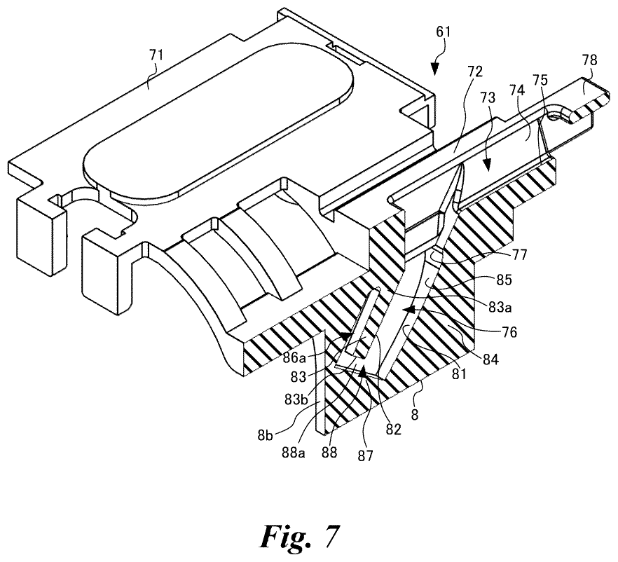

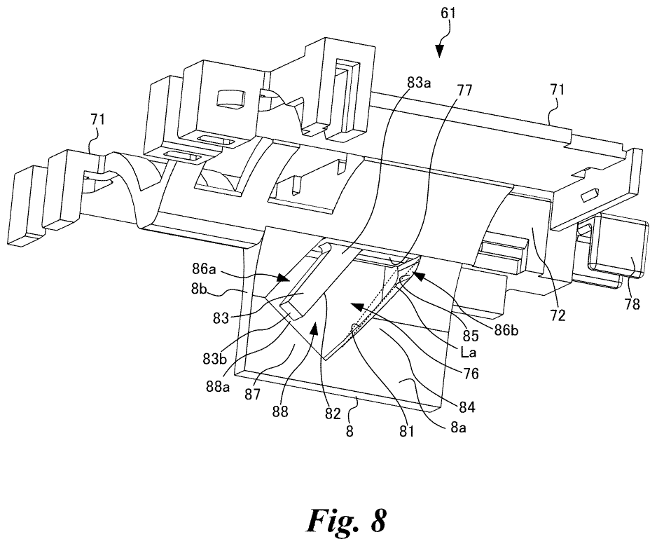

FIG. 7 is a cross-sectional view of the sensor bracket 72 taken through the engagement groove 76 and the wiring groove 73, and FIG. 8 is a perspective view of the sensor bracket 72 as viewed from the back side. As illustrated in FIGS. 7 and 8, the sensor bracket 72 is provided with a support plate 8 at the back side of the wiring groove 73.

The support plate 8 extends so as to be continuous from the bottom plate 75 of the wiring groove 73. The support plate 8 has a tabular flat surface 8a spreading downwardly from the top surface 26 of the coil 2 toward the bottom surface 25 thereof, and in the direction along the winding axis 22. The thickness direction along the short-side direction of a tabular side face 8b of the support plate 8 is orthogonal to the downward direction from the top surface 26 of the coil 2 toward the bottom surface 25 thereof.

A U-shaped space 88 bent into a U shape is formed in the support plate 8. The U-shaped space 88 extends so as to notching the support plate 8 along the tabular flat surface 8a with the opening 77 of the engagement groove 76 being as a start end. The engagement groove 76 constitutes a part of the U-shaped space 88. The U-shaped space 88 is constituted by, in addition to the engagement groove 76, a parallel opposing space portion 86a, and a U-shaped bottom 88a.

In the U-shaped space 88, the engagement groove 76 is continuous from the opening 77. The engagement groove 76 is formed straightly so as to cut obliquely through the support plate 8. An extended tip of the engagement groove 76, opposite the opening 77, does not reach the external edge of the support plate 8. The overall length of the engagement groove 76 is shorter than the overall length of the sensor 4. The engagement groove 76 obliquely intersects with the downward direction from the top surface 26 of the coil 2 toward the bottom surface 25, and extends in the direction obliquely intersecting with the winding axis 22.

The parallel opposing space portion 86a is formed so as to be elongated in parallel with the engagement groove 76 with a predetermined distance from the engagement groove 76.

The U-shaped bottom 88a is formed so as to connect the extended tip of the engagement groove 76 with the parallel opposing space portion 86a at the end of the engagement groove 76 and at the end of the parallel opposing space portion 86a.

Accordingly, first, the U-shaped space 88 extends straightly, as the engagement groove 76, from the opening 77 of the engagement groove 76 along the tabular flat surface 8a of the support plate 8. The U-shaped space 88 bends at the extended tip opposite the opening 77 of the engagement groove 76, becomes the U-shaped bottom 88a, and further extends along the tabular flat surface 8a of the support plate 8.

Moreover, the U-shaped space 88 bends at the end of the U-shaped bottom 88a, becomes the parallel opposing space portion 86a, and the parallel opposing space portion 86a is formed straightly so as to obliquely cut the support plate 8 upwardly along the tabular flat surface 8a of the support plate 8. The parallel opposing space portion 86a obliquely intersects with an upward direction from the bottom surface 25 of the coil 2 toward the top surface 26, and extends in parallel with the engagement groove 76 while extending in the direction obliquely intersecting with the winding axis 22.

Here, the extended tip of the parallel opposing space portion 86a does not reach the top surface of the sensor bracket 72. Moreover, the parallel opposing space portion 86a and the engagement groove 76 are in communication with each other at the U-shaped bottom 88a. Furthermore, at least the portion of the fitting groove 76 near the extending tip opposite the opening 77, the U-shaped bottom 88a, and the parallel opposing space portion 86a near the connection portion with the U-shaped bottom 88a are formed by cutting out the support plate 8, and penetrate the support plate 8 in the thickness direction.

Therefore, an elastic plate piece 83 remains between the engagement groove 76 and the parallel opposing space portion 86a. The elastic plate piece 83 extends along the engagement groove 76. The opening-77-side of the engagement groove 76 that is the basal portion of the elastic plate piece 83 extends from the support plate 8, and becomes a fixed end 83a. The end of the elastic plate piece 83 that is an extended tip facing the U-shaped bottom 88a becomes a free end 83b.

When the support plate 8 is partitioned, the elastic plate piece 83 extends between the engagement groove 76 and the parallel opposing space portion 86a. A fixed plate piece 84 that is unable to elastically deform is present and extends at the side opposite the elastic plate piece 83 with the engagement groove 76 being present therebetween. A block-off plate piece 87 is present and extends at the end of the engagement groove 76.

In other words, the engagement groove 76 extends between the fixed plate piece 84 and the elastic plate piece 83. The sensor 4 is held by a gripping surface 81 of the fixed plate piece 84 facing the elastic plate piece 83, and a gripping surface 82 of the elastic plate piece 83 facing the fixed plate piece 84. The gripping surface 82 of the elastic plate piece 83 is provided along the side face of the sensor 4. Conversely, a virtual line La in FIG. 8 represents the side face of the sensor 4, and the gripping surface 81 of the fixed plate piece 84 is recessed deeper than the virtual line La, and thus a curved recess 85 is formed. The curved recess 85 has a keen inclination at the opening-77 side of the engagement groove 76, and becomes gradually shallow toward the extended tip of the engagement groove 76.

When the insertion of the sensor 4 completes, i.e., when the sensor 4 reaches the block-off plate piece 87, the sensor 4 and the curved recess 85 are not being in contact with each other, but a circular-arc space portion 86b is defined between the sensor 4 and the curved recess 85. In a comparison between the parallel opposing space portion 86a and the circular-arc space portion 86b, the parallel opposing space portion 86a is cut out so as to expand with a larger volume than that of the circular-arc space portion 86b.

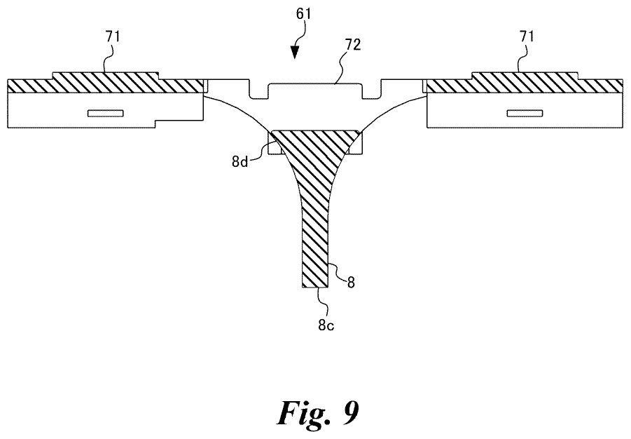

FIG. 9 is a cross-sectional view of the sensor bracket 72 taken along the direction orthogonal to the winding axis 22. As illustrated in FIG. 9, when such a support plate 8 is inserted between the circular cylindrical or rounded-rectangular cylindrical coils 2, a plate lower portion 8c decreases the thickness and becomes thinner than a plate upper portion 8d in accordance with the interval between the coils 2 where the bottom becomes narrow, and the plate upper portion 8d expands and becomes thicker than the plate lower portion 8c in accordance with the interval between the coils 2 where the superficial portion is wide. The plate lower portion 8c is located at the bottom side of the interval between the coils 2, and the plate upper portion 8d is located at the opening-77 side of the engagement groove 76.

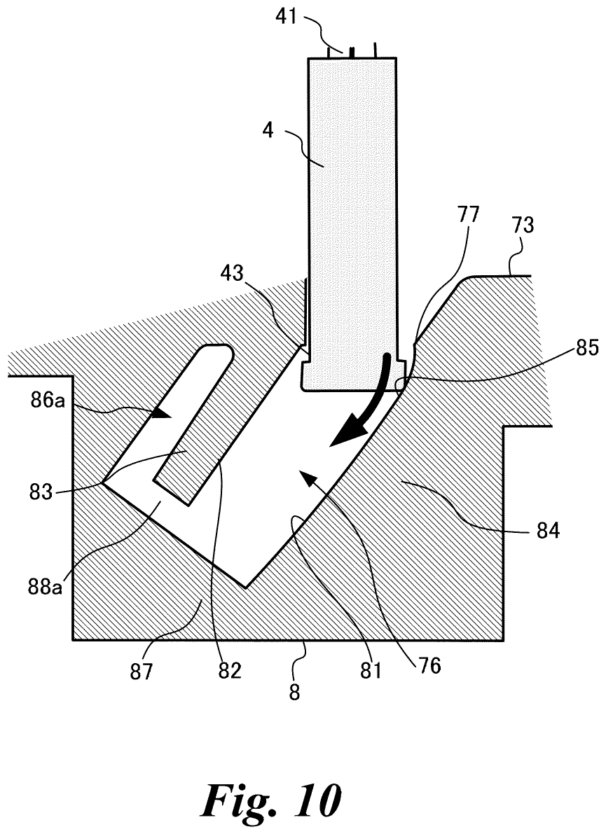

The attachment process of the sensor 4 to such a sensor bracket 72 will be described. FIG. 10 illustrates a first sub process of attaching the sensor 4, and is a cross-sectional view of the sensor bracket 72 taken along the winding axis 22 through the engagement groove 76 and the wiring groove 73.

As illustrated in FIG. 10, the tip corner of the sensor 4 is inserted into the opening 77 of the engagement groove 76, and the tip of sensor 4 is caused to abut the curved recess 85. Next, the sensor 4 is pushed therein as if the curved recess 85 is scraped by the corner of the sensor 4. The curved recess 85 is a recess along the trajectory traced by the tip of the sensor 4 from a state in which the sensor 4 is vertical when inserted into the opening 77 to a state in which an engagement protrusion 43 of the sensor 4 is engaged with the elastic plate piece 83 and is held obliquely in the engagement groove 76. This facilitates the sensor 4 to be inserted into the engagement groove 76.

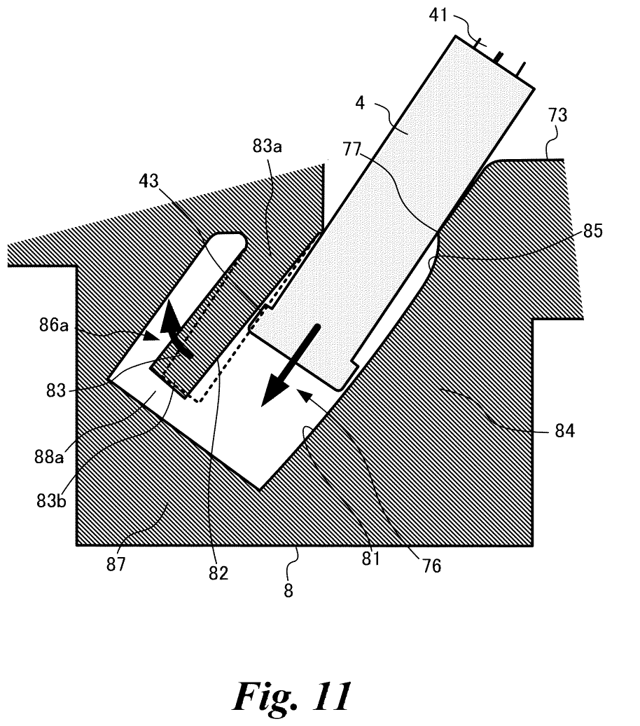

Next, FIG. 11 illustrates a second sub process of attaching the sensor 4, and is a cross-sectional view of the sensor bracket 72 taken along the winding axis 22 through the engagement groove 76 and the wiring groove 73. When the sensor 4 is inserted toward the bottom of the engagement groove 76, since the elastic plate piece 83 has the fixed end 83a on the opening-77 side of the engagement groove 76, and has the free end 83b on the bottom side of the engagement groove 76, the engagement groove 76 elastically deforms so as to expand in accordance with the press-fitting of the sensor 4.

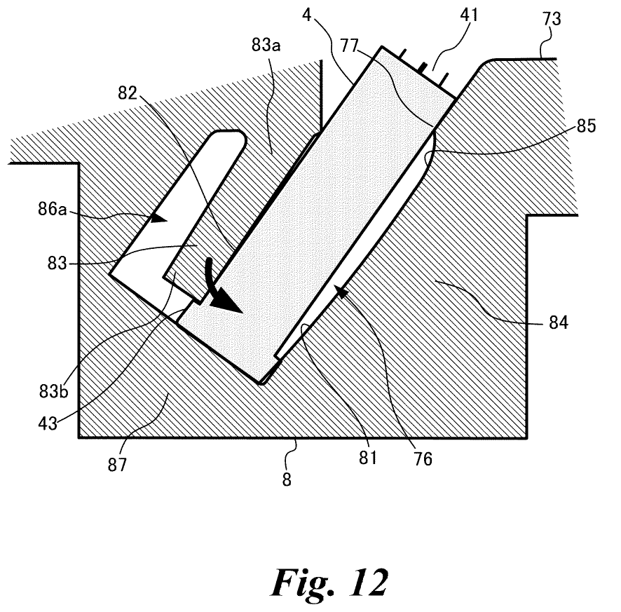

Subsequently, FIG. 12 illustrates a third sub process of attaching the sensor 4, and is a cross-sectional view of the sensor bracket 72 taken along the winding axis 22 through the engagement groove 76 and the wiring groove 73.

In the engagement groove 76, the sensor 4 abuts the block-off plate piece 87, and stops. The engagement protrusion 43 that protrudes from the side face of the body of the sensor 4 is provided at the tip of the sensor 4. When the sensor 4 abuts the block-off plate piece 87, the elastic plate piece 83 returns to the original position so as to tighten the sensor 4 by elasticity. Next, since the elastic plate piece 83 is latched with the engagement protrusion 43, a possibility such that the sensor 4 is pushed back from the engagement groove 76 by the holding force of the engagement groove 76 is Suppressed, and thus the gripping by the engagement groove 76 is further enhanced.

In the installation process that is a post-process of the attachment process, the top cover 61 including the sensor bracket 72, the end covers 62, the inner circumferential cylinders 63, and the side covers 64 are attached to the coils 2. Subsequently, the coils 2 are accommodated in a die for the molding process.

In the molding process, a molten resin is injected into the die from an injection gate. However, since the sensor 4 is tightly clamped at the opening 77 of the engagement groove 76, a possibility such that the molten resin leaks in the wiring groove 73 from the gap between the opening 77 of the engagement groove 76 and the circumference of the body of the sensor 4 is suppressed. Accordingly, the coil molding resin 91 is not substantially formed in the wiring groove 73.

Moreover, the lead wire 41 is exposed from the coil molding resin 91. During the molding process, the injection pressure of the molten resin is not intensively applied to the lead wire 41. Hence, the lead wire 41 can be routed in the wiring groove 73 without being covered with, for example, the resin, and thus the number of components for the sensor 4 can be reduced by what corresponds to the exposed lead wire 41.

Moreover, since the sensor 4 is tightly clamped by the gripping surface 82 of the engagement groove 76 and the gripping surface 81 thereof, an occasion such that the molten resin goes up near the opening 77 of the engagement groove 76 is suppressed. Because of the engagement between the engagement protrusion 43 and the elastic plate piece 83, a possibility such that the sensor 4 is pushed away by the molten resin and displaced in the direction detached from the engagement groove 76, and the tightening by the gripping surface 82 of the engagement groove 76 and the gripping surface 81 thereof, and the tightening by the opening 77 of the engagement groove 76 are loosened is suppressed.

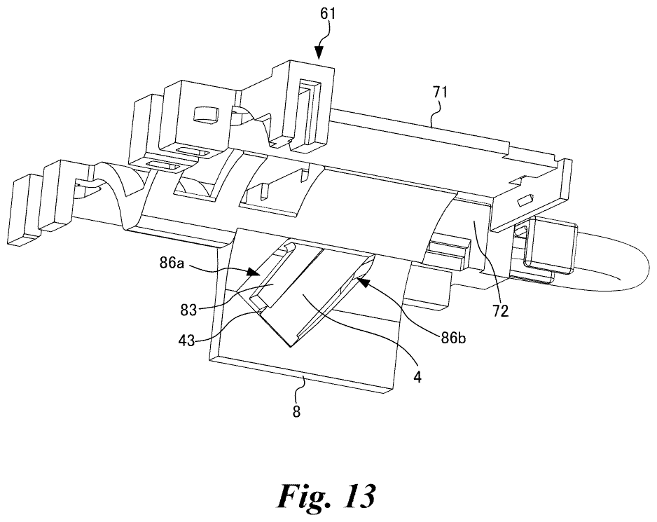

FIG. 13 is a perspective of the sensor bracket 72 and the sensor 4 in the molding process as viewed from the back side. As illustrated in FIG. 13, the parallel opposing space portion 86a has a larger volume than that of the circular-arc space portion 86b defined by the sensor 4 and by the curved recesses 85. Hence, a larger amount of the molten resin enters the parallel opposing space portion 86a than the circular-arc space portion 86b. Therefore, the molten resin in the parallel opposing space portion 86a causes the elastic plate piece 83 to be intimately in contact with the sensor 4. The free end 83b of the elastic plate piece 83 contacts the basal portion of the engagement protrusion 43 with pressure while being firmly latched therewith. This further prevents the sensor 4 from being detached from the engagement groove 76.

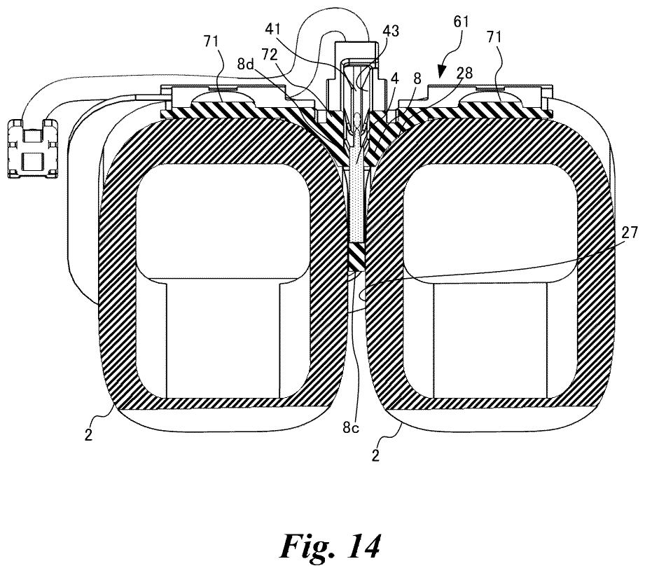

FIG. 14 is a cross-sectional view of the sensor bracket and the coils taken along the overall length of the sensor. As illustrated in FIG. 14, the plate lower portion 8c of the support plate 8 has the same width as that of the sensor 4 or is slightly thicker than such a width. Hence, when the sensor 4 is inserted into the engagement groove 76, the surface of the sensor 4 become flush with the surface of the support plate 8, or the surface of the sensor 4 is located at a lower position relative to the surface of the support plate 8, and is hidden by the surface of the support plate 8.

Hence, the sensor 4 can be hidden by the support plate 8, and the injection pressure to be applied to the sensor 4 decreases. Since the injection pressure of the molten resin applied to the sensor 4 decreases, an occasion such that the sensor 4 is pushed away and displaced by the injection pressure is suppressed. Since the displacement of the sensor 4 is suppressed, a possibility such that the molten resin leaks into the wiring groove 73 from the gap between the opening 77 of the engagement groove 76 and the circumference of the body of the sensor 4 is further suppressed.

Meanwhile, as illustrated in FIG. 14, the plate upper portion 8d of the support plate 8 becomes thicker toward the upper side so as not to increase the distance between the curved surface 28 of each coil 2 and the tabular flat surface 8a of the support plate 8. Hence, the molten resin does not spurt vigorously into the space between each coil 2 and the support plate 8, but the molten resins slowly fill the space between each coil 2 and the support plate 8. Hence, an occasion such that the molten resin leaks in the wiring groove 73 from the gap between each coil 2 and the support plate 8, and contacts with the lead wire 41 is suppressed.

As described above, the molded coil 5 includes the coils 2, the sensor bracket 72 installed on the coils 2, the sensor 4 attached to the sensor bracket 72, and the coil-molding resin 91 that covers at least the coils 2 and a part of the sensor 4. Moreover, the sensor bracket 72 is provided with the engagement groove 76 into which the sensor 4 is inserted. In addition, the engagement groove 76 includes the opening 77 that surrounds the entire circumference of the body of the sensor 4, and the pair of gripping surfaces 81 and 82 which holds the sensor 4 from both sides thereof within the engagement groove 76. One of the gripping surfaces 81 and 82 is the elastic plate piece 83 which spreads along the depthwise direction of the engagement groove 76, has one end fixed, and has the other end as a free end.

According to this molded coil 5, since the opening 77 of the engagement groove 76 into which the sensor 4 is inserted, surrounds the body of the sensor 4 over the entire circumference thereof, an attempt is accomplished to suppress an occasion such that the molten resin leaks in the region where the lead wire 41 is present in the molding process.

Hence, in the attachment process through the manufacturing procedure of the molded coil 5, the sensor 4 is inserted into the engagement groove 76 while elastically deforming the elastic plate piece 83, and the opposite end from which the lead wire 41 is drawn is disposed so as to protrude from the engagement groove 76. Accordingly, even if the sensor 4 is further surely surrounded by the opening 77 of the engagement groove 76 and the circumference of the body of the sensor 4 is further tightened by the engagement groove 76, the elastic plate piece 83 allows the sensor 4 to be inserted into the engagement groove 76.

Hence, according to the molded coil 5, it is further surely suppressed, in the molding process, that the molten resin leaks in the region where the lead wire 41 is present.

Therefore, the sensor 4 can be protected against the disconnection of the lead wire 41 due to the injection pressure of the resin and against the melting of the cover portion of the lead wire 41 due to the heat of the resin without molding the lead wire 41 in advance and attachment thereof to a sensor cover that is a separate component. This enables elimination of the molding of the lead wire 41 and of the sensor cover that is a separate component, reducing the number of components. Hence, the production efficiency is improved.

Moreover, the sensor 4 includes the engagement protrusion 43 that is latched with the free end 83b of the elastic plate piece 83, and the free end 83b of the elastic plate piece 83 contacts the basal portion of the engagement protrusion 43 with pressure. This suppresses a detachment of the sensor 4 from the engagement groove 76. Accordingly, even if a larger force is required to press-fit the sensor 4, the sensor 4 is less likely to return in the direction detached from the engagement groove 76, and a possibility such that a gap is formed between the circumference of the body of the sensor 4 and the opening 77 of the engagement groove 76 is reduced.

Furthermore, the other one of the pair of gripping surfaces 81 and 82 includes the curved recess 85 that guides the tip of the sensor 4 toward the bottom of the engagement groove 76. Hence, even if the opening 77 and the engagement groove 76 are made narrower and necessary force for inserting the sensor 4 is increased, the sensor 4 can be easily press-fitted into the engagement groove 76. Accordingly, the circumference of the body of the sensor 4 can be further tightened by the opening 77 of the engagement groove 76, and thus it is further surely suppressed, in the molding process, that the molten resin leaks in the region where the lead wire 41 is present.

Still further, the sensor bracket 72 includes the parallel opposing space portion 86a that is present so as to extend along the elastic plate piece 83 on the side opposite the engagement groove 76 across the elastic plate piece 83, and the parallel opposing space portion 86a is caused to have a larger volume than that of the circular-arc space portion 86b defined by the curved recess 85 and the sensor 4.

Hence, the amount of the flow-in molten resin in the molding process becomes greater at the parallel opposing space portion 86a than at the circular-arc space portion 86b. Therefore, the molten resin in the parallel opposing space portion 86a pushes the elastic plate piece 83 toward the sensor 4, enabling the free end 83b of the elastic plate piece 83 to contact the basal portion of the engagement protrusion 43 while being further firmly latched therewith.

Moreover, each coil 2 is formed so as to have a rounded-rectangular cross section spreading along the vertical direction to the winding axis 22. Furthermore, at least two coils 2 are provided and are arranged side by side with the respective circumferential surfaces of the coils 2 facing each other. The sensor bracket 72 is installed in such a way that the sensor 4 enters the interval between the two coils 2. The sensor bracket 72 includes the support plate 8 which spreads along the winding axis 22 of each coil 2, and which is fitted in the interval between the coils 2. The support plate 8 is notched along the winding axis 22 of coil 2 so as to include the engagement groove 76 and the elastic plate piece 83, and the plate upper portion 8d is made thicker than the plate lower portion 8c.

This enables the molten resin to be slowly filled in the interval between each coil 2 and the support plate 8 without increasing the distance between the support plate 8 and the circumferential surface of each coil 2. Hence, it is suppressed that the molten resin leaks in the wiring groove 73 from the gap between each coil 2 and the support plate 8, and contacts with the lead wire 41.

Note that each coil 2 is formed in a rounded-rectangular cylindrical shape, but each coil 2 may be formed in a cylindrical shape. Even in the case of the coil 2 that is formed in the cylindrical shape, it is still appropriate if the plate upper portion 8d of the support plate 8 should become thicker toward the upper part so as not to increase the distance between the curved surface 28 of the coil 2 and the tabular flat surface 8a of the support plate 8. Moreover, each coil 2 may be formed in, in addition to the cylindrical shape and the rounded-rectangular cylindrical shape, a rectangular cylindrical shape.

It is appropriate that, as for the support plate 8, the plate upper portion 8d is thicker than the plate lower portion 8c, and the change in such a thickness should increase in accordance with the outer circumferential shape of each coil 2, but even if it does not completely match with the outer circumferential shape of each coil 2, it is still suppressed that the molten resin leaks in the wiring groove 73 from the gap between each coil 2 and the support plate 8, and contacts with the lead wire 41.

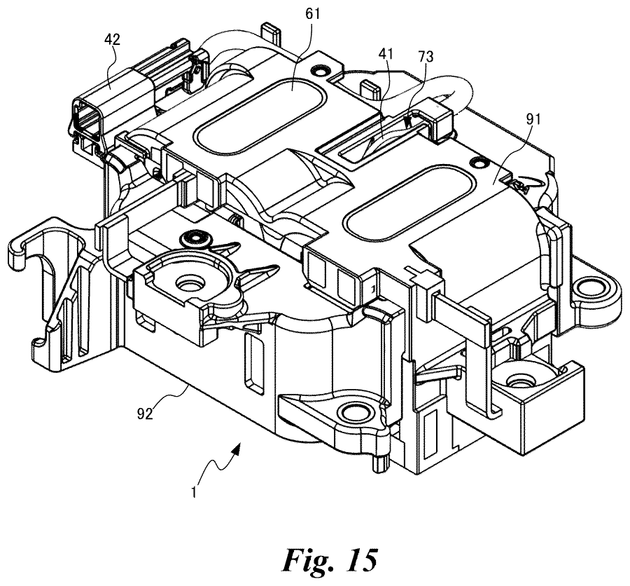

Such a molded coil 5 can be utilized in an assembling process of the reactor 1. FIG. 15 is a perspective view of the reactor 1 covered with the coil-molding resin 91 and with the core-molding resin 92.

As illustrated in FIG. 15, the reactor 1 is manufactured through the assembling process of attaching the molded coil 5 produced by this manufacturing method to the core 3 covered with the core-molding resin 92. The annular core 3 is formed by combining divided parts, and after the molded coil 5 is fitted onto the parts of the core 3, the core 3 is assembled in an annular shape. The core-molding resin 92 may be formed by molding with the core 3 being accommodated in a die, or the core 3 and the molded coil 5 may be accommodated in the die and insert molding may be performed on the core 3 and on the molded coil 5 so as to integrate those components with each other by the core-molding resin 92.

Although the embodiment of the present disclosure has been presented as merely an example, the present disclosure is not limited to the above-described embodiment. The above-described embodiment can be implemented in other various forms, and various omissions, replacements and modifications can be made thereto without departing from the scope and spirit of the present disclosure. Such an embodiment and modified example thereof fall in the scope and spirit of the present disclosure.

What is claimed is:

1. A molded coil comprises:
a coil;
a sensor bracket installed on the coil;
a sensor attached to the sensor bracket; and
a molding resin that covers at least the coil and a part of the sensor,
wherein:
the sensor bracket is provided with an engagement groove into which the sensor is inserted;
the engagement groove comprises an opening that surrounds an entire circumference of a body of the sensor, and a pair of gripping surfaces which holds the sensor from both sides thereof within the engagement groove; and
wherein either one of the gripping surfaces is an elastic plate piece which spreads in a depthwise direction of the engagement groove, has one end fixed, and has the other end as a free end.

2. The molded coil according to claim 1, wherein:
the sensor comprises a lead wire drawn from an opposite end to a fitting-side tip of the sensor inserted into the engagement groove; and
the sensor is disposed with the opposite end protruding from the engagement groove.

3. The molded coil according to claim 1, wherein:
the sensor comprises an engagement protrusion that is latched with the free end of the elastic plate piece; and
the free end of the elastic plate piece contacts a basal portion of the engagement protrusion with pressure.

4. The molded coil according to claim 1, wherein the other one of the pair of gripping surfaces comprises a curved recess that guides a fitting-side tip of the sensor toward a bottom of the engagement groove.

5. The molded coil according to claim 4, wherein:
the sensor bracket comprises a space portion that is present so as to extend along the elastic plate piece at a side opposite to the engagement groove across the elastic plate piece; and
the space portion has a larger volume than a volume of a space defined by the curved recess and the sensor.

6. The molded coil according to claim 1, wherein:
the coil is formed so as to have a circular or rounded-rectangular cross section spreading along a vertical direction to an axis;
at least the two coils are provided which are arranged side by side with respective circumferential surfaces of the coils facing each other;
the sensor bracket is installed in such a way that the sensor enters an interval between the two coils;
the sensor bracket comprises a support plate which spreads along the axial direction of the coil, and which is fitted in the interval between the coils;
the support plate is notched along the axial direction of coil so as to comprise the engagement groove and the elastic plate piece; and
a plate upper portion of the support plate is made thicker than a plate lower portion thereof.

7. The molded coil according to claim 6, wherein the support plate increases a thickness along an outer circumferential shape of the coil.

8. The molded coil according to claim 1, wherein the sensor is a temperature sensor.

9. A reactor comprising:
the molded coil according to claim 1; and
an annular core which comprises a magnetic body, and which is attached to the molded coil.

10. A manufacturing method for a molded coil comprising a coil, a sensor, a sensor bracket to which the sensor is attached and which is disposed on the coil, and a molding resin that covers at least the coil and a part of the sensor, the method comprising:
an attachment process of attaching the sensor to the sensor bracket;
an installation process of installing the sensor bracket on the coil; and
a molding process of accommodating the coil on which the sensor bracket is installed in a die, and of injecting the mold resin therein,
wherein:
the sensor bracket is provided with an engagement groove into which the sensor is inserted;
the engagement groove comprises an opening that surrounds an entire circumference of a body of the sensor, and a pair of gripping surfaces which holds the sensor from both sides thereof in the engagement groove;
either one of the gripping surfaces is an elastic plate piece which spreads in a depthwise direction of the engagement groove, has one end fixed, and has the other end as a free end;
the sensor comprises a lead wire drawn from an opposite end to a fitting-side tip of the sensor inserted into the engagement groove; and
in the attachment process, the sensor is press-fitted in the engagement groove while causing the elastic plate piece to be elastically deformed, and is placed in such a way that the opposite end from which the lead wire is drawn protrudes from the engagement groove.

11. A manufacturing method for a reactor comprising an assembling process of attaching the molded coil to the core comprising a magnetic body after through the molded coil manufacturing method according to claim 10.
